(19) United States
(12) Patent Application Publication
(10) Pub. No.: US 2023/0008923 A1
(43) Pub. Date: Jan. 12, 2023

(54) INFORMATION PROCESSING DEVICE

(71) Applicant: TOYOTA JIDOSHA KABUSHIKI KAISHA, Toyota-shi Aichi-ken (JP)

(72) Inventors: Daiki Yokoyama, Gotemba-shi Shizuoka-ken (JP); Akihito Ito, Inazawa shi Aichi ken (JP); Ryo Nakabayashi, Susono-shi Shizuoka-ken (JP); Tatsuya Imamura, Okazaki-shi Aichi-ken (JP); Tomohiro Kaneko, Mishima-shi Sjizuoka-ken (JP); Hiroki Murata, Gotemba-shi Shizuoka-ken (JP)

(73) Assignee: TOYOTA JIDOSHA KABUSHIKI KAISHA, Toyota-shi Aichi-ken (JP)

(21) Appl. No.: 17/859,654

(22) Filed: Jul. 7, 2022

(30) Foreign Application Priority Data
Jul. 9, 2021 (JP) 2021-114378

(51) Int. Cl. G06N 20/00

(52) U.S. Cl. CPC G06N 20/00

(57) ABSTRACT

A processor of a control device of a server for machine learning a plurality of models with different output parameters, comprising a receiving part for receiving information from a plurality of equipment connected to be able to communicate, a learning use data set preparing part for using information which the receiving part receives to prepare a learning use data set for each model, and a learning part for machine learning with priority a model with a high priority order in models for which the number of data sets required for learning have been prepared based on the priority orders of learning among models if the number of data sets required for learning have been prepared for a plurality of models.

### CROSS-REFERENCE TO RELATED APPLICATION

This application claims priority to Japanese Patent Application No. 2021-114378 filed on Jul. 9, 2021, incorporated herein by reference in its entirety.

### FIELD

The present disclosure relates to an information processing device.

### BACKGROUND

In a “smart city”, it becomes necessary to collect data from a plurality of entities (business entities) in the community, but due to the variation among the entities, the data collected becomes indefinite. In consideration of this, for example, as described in Japanese Unexamined Patent Publication No. 2013-69084, it is known to receive surveillance data from external devices, calculate correction information for the surveillance data based on the information of the external devices, add the results of calculation to the surveillance data to obtain corrected data, and, based on this, extract external devices for control and send control information to the extracted external devices.

In a smart city, it is envisioned to collect various information from things and people inside it and put it to use in learning utilizing artificial intelligence. The collected information and the learning targets are diverse and numerous. It is sought to process the diverse and numerous big data and learn an extremely large range of learning targets. For this reason, it was de facto impossible to simultaneously learn all of the learning targets.

Therefore, embodiments of the present disclosure have as their object the provision of an information processing device able to performing learning in a suitable order.

Embodiments of the present disclosure were made so as to solve the above problem and the present disclosure has as its gist the following.

(1) An information processing device for machine learning a plurality of models with different output parameters, the information processing device comprising:
a processor configured to:
receive information from a plurality of equipment connected to be able to communicate,
prepare a learning use data set for each model by using information which the receiving part receives, and
machine learn with priority a model with a high priority order in models for which the number of data sets required for learning have been prepared based on the priority orders of learning among models if the number of data sets required for learning have been prepared for a plurality of models.

(2) The information processing device according to above (1), wherein a priority order of learning of a model having an output parameter of a parameter relating to human life is set higher than a priority order of learning of a model with an output parameter not related to human life.

(3) The information processing device according to above (1), wherein the processor is configured to, during learning of models, even if there are models for which the number of data sets required for learning have been prepared and which are standing by for learning, not learn the standing by models until the model being learned finishes being learned and machine learn with priority a model with a high priority order among the standing by models if the model being learned finishes being learned.

(4) The information processing device according to above (1), wherein the processor is configured to, if a priority order of learning of a model for which the number of data sets required for learning have newly been prepared is higher than a priority order of learning of the model currently being learned, suspend learning of the model currently being learned and learn by priority the model for which the number of data sets required for learning have newly been prepared.

(5) The information processing device according to above (1), wherein the processor is configured to, if there is a model for which a reference number of data sets more than the number required for the learning have been prepared, machine learn by priority the model for which the reference number of data sets have been prepared regardless of the priority order.

(6) The information processing device according to above (1), the processor is further configured to determine the priority order based on a frequency of occurrence of a predetermined event when the output parameter is a probability of occurrence of the event, a relevance between an output parameter and human life, or a difficulty of prediction of a value of the output parameter.

According to embodiments of the present disclosure, the effect is exhibited that it becomes possible to provide an information processing device able to performing learning in a suitable order.

### BRIEF DESCRIPTION OF DRAWINGS

FIG. 1 is a schematic view showing a machine learning system according to one embodiment.

FIG. 2 is a schematic view showing a configuration of a server.

FIG. 3 is a schematic view showing functional blocks of a processor of a control device provided at the server.

FIG. 4 is a schematic view showing one example of a neural network by which a learning part performs learning based on learning use data sets and prepares a learned model.

FIG. 5 is a flow chart showing processing which a processor of a control device of the server performs.

FIG. 6 is a flow chart showing processing which a processor of a control device of the server performs.

FIG. 7 is a flow chart showing processing which a processor of a control device of the server performs.

FIG. 8 is a functional block diagram of a processor relating to processing for analyzing electrocardiogram information.

FIG. 9A is a view showing one example of a frequency spectrum of an electrocardiogram waveform.

FIG. 9B is a view showing one example of a frequency spectrum of an electrocardiogram waveform.

FIG. 10 is a view showing one example of an electrocardiogram waveform.

FIG. 11A is a view showing one example of intervals between two peaks in an electrocardiogram waveform.

FIG. 11B is a view showing one example of intervals between two peaks in an electrocardiogram waveform.

### DESCRIPTION OF EMBODIMENTS

Below, several embodiments according to the present disclosure will be explained while referring to the drawings. However, the explanation of these is intended as just illustration of embodiments of the present disclosure and is not intended as limiting the present disclosure to such specific embodiments.

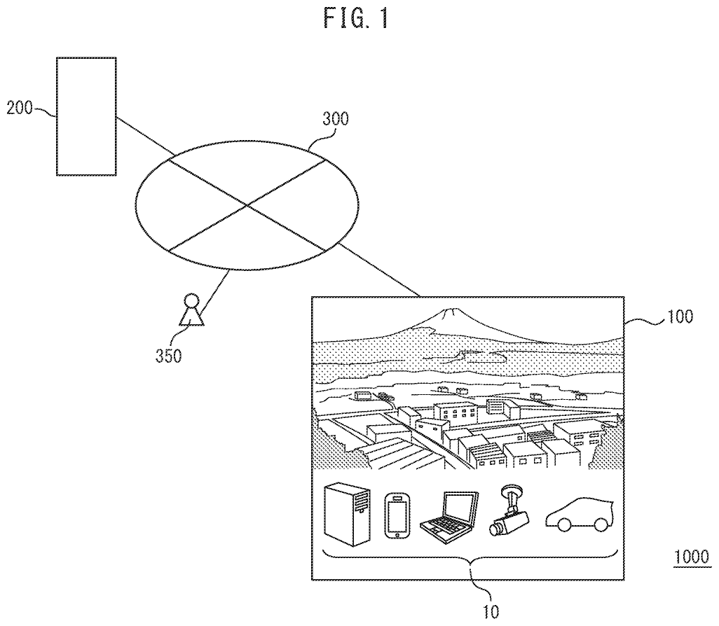

FIG. 1 is a schematic view showing a machine learning system 1000 according to one embodiment. In this machine learning system 1000, the various equipment 10 in a smart city 100 and a server 200 are able to communicate with each other. Specifically, the various equipment 10 in the smart city 100 and the server 200 are able to communicate with each other through a communication network 300 configured by optical communication lines etc. The communication network 300 relays communication between the various equipment 10 in the smart city 100 and the server 200 by cables.

Further, the various equipment 10 in the smart city 100 and the server 200 may also communicate with each other through a communication network 300 and a wireless base station 350 connected with the communication network 300 through a gateway (not shown). The wireless base station 350 wirelessly relays communication between the various equipment 10 in the smart city 100 and the server 200 through the communication network 300.

Note that, a “smart city” is, for example, a sustainable city or region, as propounded by Japan's MLIT, where the various issues faced by the city are managed (through planning, construction, management/operation, etc.) while making use of ICT (Information and Communication Technology) and other new technologies to enable overall optimization. A “connected city”, which is a demonstration city in which all sorts of things and services are connected, is one form of a smart city 100. Note that, in a smart city or connected city, sometimes automated driving vehicles (automated driving buses) will be operated to transport visitors to their destinations (visit spots).

The various equipment 10 in a smart city 100 include equipment which vehicles running inside the smart city 100 by automated driving or manual driving are provided with (ECUs, various sensors, navigation devices, etc.), equipment which facilities inside the smart city 100 (housing, stores, factories, hospitals, train stations, etc.) are provided with (various sensors, computers, etc. which these facilities are provided with), equipment installed at the roads, open areas, etc. inside the smart city 100 (various sensors, surveillance cameras, etc.), equipment which people inside the smart city 100 own or wear (smart phones, wearable devices, etc.), and all sorts of other equipment able to communicate with the server 200 inside the smart city 100. These equipment 10 include ones used in a single facility and ones used spanning several facilities. In the machine learning system 1000, using the IoT (Internet of Things) constructed by these equipment 10 and the server 200 being connected to be able to communicate, the server 200 can recognize and, further, can predict, events inside the smart city 100.

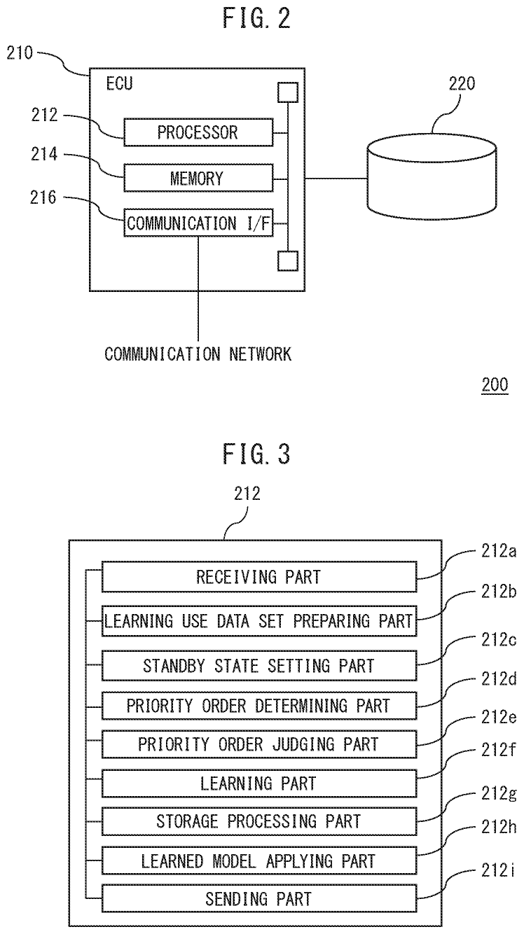

The server 200 performs machine learning by deep learning and other techniques for events inside the smart city 100 to prepare learned models based on the data obtained from the various equipment 10 in the smart city 100. The prepared learned models are stored in a storage device 220 of the server 200 (see FIG. 2). Further, the server 200 recognizes and predicts events inside the smart city 100 by artificial intelligence (AI) utilizing the prepared learned models. The equipment 10 inside the smart city 100 can access the server 200 and utilize the artificial intelligence using the learned models. Further, the server 200 can send the learned models to the equipment 10 trying to utilize the learned models. By doing the above, the server 200 manages the several learned models which various equipment 10 in the smart city 100 utilize.

There are diverse types of equipment 10 in the smart city 100, so the data obtained from the various equipment 10 in the smart city 100 becomes giant groups of data (big data). Further, there are diverse types of models covered by the machine learning by the server 200 using these data groups. The types become extremely numerous.

In the server 200 learning events in the smart city 100, since there is a limit to the processing ability of the server 200, sometimes it is not possible to machine learn several models at one time. On the other hand, if successively machine learning several models in a random order, sometimes models with low importance will be learned before learning of models with high importance.

In the present embodiment, a plurality of models with different output parameters are respectively assigned priority orders. For example, models used in hospitals and other models relating to human life (models relating to medicine) are set with priority orders higher than other models and are learned with priority. Due to this, models with relatively lower importance are kept from being learned before models relating to human life are learned and as a result learning is conducted in a suitable order.

Note that, as examples of models relating to human life, models having as their output parameters a probability of heat stroke, a probability of irregular heart rhythm, a number of persons infected, or a number of persons with metabolic diseases may be mentioned. Further, as examples of models relating to human life, models having as their output parameters a number of available hospital beds, a number of hospitalized patients, a number of outpatients, a medical burden, a number of attending physicians, or a degree of health of a region or other models for maintaining the medical system may be mentioned. Further, as models other than models relating to human life, for example, a model having as an output parameter an operating state of vehicles inside the smart city 100, a model having as an output parameter an amount of traffic of vehicles inside the smart city 100 (including projections of state of congestion), a model having as an output parameter a weather inside the smart city 100 and its surroundings (including forecasts of weather, air temperature, and humidity), a model having as an output parameter a supply of electric power inside the smart city 100 (including projections of electric power supply and demand), etc. may be mentioned.

Note that, if the supply of electric power inside the smart city 100 is shut down, the functions of the smart city 100 will become paralyzed, so the priority order of a model relating to the supply of electric power inside the smart city 100 may be made next highest after a model relating to human life inside the smart city 100. Further, the priority order of a model relating to the operating state of vehicles or the amount of traffic may be made next highest after a model relating to the supply of electric power inside the smart city 100.

Further, while explained in detail later, a model relating to human life includes several subdivided models. For example, individual subdivided models such as “probability of occurrence of heat stroke” or “probability of occurrence of irregular heart rhythm” may also be assigned priority orders. Similarly, the models other than the model relating to human life may also include pluralities of subdivided models and the individual subdivided models may also be assigned priority orders.

In the above way, in a smart city 100, various information is collected from things and people inside of it and put to use for learning by the server 200 utilizing artificial intelligence. The collected information and the models are diverse and numerous. The server 200 is asked to process the diverse and numerous big data and learn the extremely many models. On the other hand, there are limits to the processing ability of the server 200, so it is next to impossible in practice to simultaneously learn all of the models. Therefore, according to the present embodiment, models having different output parameters are assigned priority orders so that they can be learned successively in accordance with the priority orders, so it becomes possible to learn diverse and numerous models without exceeding the processing ability of the server 200.

FIG. 2 is a schematic view showing the configuration of the server 200. The server 200 has a control device 210 and a storage device 220.

The control device 210 has a processor 212, a memory 214, and a communication interface 216. The processor 212 is one form of an information processing device and has one or more CPUs (central processing units) and their peripheral circuits. The processor 212 may further have a logic unit, arithmetic unit, or graphic processing unit or other such processing circuit. The memory 214, for example, has a volatile semiconductor memory and nonvolatile semiconductor memory. The communication interface 216 has an interface circuit for connecting the control device 210 to a network inside the server 200 or the communication network 300. The communication interface 216 is configured to enable communication with the various equipment 10 in the smart city 100 through the communication network 300 (and the wireless base station 350). That is, the communication interface 216 transfers the various information (sensor values, input values to learned models, etc.) received from the various equipment 10 in the smart city 100 through the communication network 300 (and the wireless base station 350) to the processor 212. Further, the communication interface 216 sends the output values of the learned models or the learned models themselves etc. received from the processor 212 through the communication network 300 (and the wireless base station 350) to the various equipment 10 in the smart city 100.

The storage device 220, for example, has a hard disk drive or optical storage medium and access devices for the same. The storage device 220 stores the learned models etc. obtained as a result of learning. Note that, the storage device 220 may also store a computer program for performing processing run on the processor 212.

FIG. 3 is a schematic view showing the functional blocks of the processor 212 of the control device 210 provided at the server 200. The processor 212 of the control device 210 is one form of an information processing device and has a receiving part 212a, a learning use data set preparing part 212b, a standby state setting part 212c, a priority order determining part 212d, a priority order judging part 212e, a learning part 212f, a storage processing part 212g, a learned model applying part 212h, and a sending part 212i. These parts of the processor 212 are, for example, functional modules realized by a computer program running on the processor 212. That is, these parts of the processor 212 are configured from the processor 212 and a program (software) for making it function. Further, this program may be recorded in the memory 214 of the control device 210 or a recording medium connected from the outside. Alternatively, these parts of the processor 212 may be dedicated processing circuits provided at the processor 212.

The receiving part 212a of the processor 212 receives information from the plurality of equipment 10 connected to be able to communicate. Specifically, the receiving part 212a receives information from the various equipment 10 in the smart city 100 through the communication network 300 (and the wireless base station 350).

The learning use data set preparing part 212b of the processor 212 uses the information which the receiving part 212a received to classify and combine the various data included in the received information and thereby prepare learning use data sets for the different models. The learning use data set preparing part 212b prepares learning use data sets for the different models, so the learning use data sets which the learning use data set preparing part 212b prepares differ according to the model. The data sets which the learning use data set preparing part 212b prepares are stored in the storage device 220.

The standby state setting part 212c of the processor 212 sets the learning of a model in which a predetermined value (first threshold value) or more of the learning use data sets required for starting learning is stored to the standby state. The predetermined value required for starting learning is a value determined for each model and is determined by the estimated scale of the data set for each model. Basically, the predetermined value required for starting learning becomes larger the more sophisticated the learning becomes. The predetermined value required for starting learning may be a value determined in advance for each model and may be stored in the memory 214 of the control device 210 of the server 200 or the storage device 220.

The priority order determining part 212d of the processor 212 determines a priority order of learning for each model. For example, when the output parameter of a model is the probability of occurrence of a predetermined event, the priority order determining part 212d may raise the priority order in accordance with the frequency of occurrence of that event the higher the frequency of occurrence. For example, among models relating to human life, the frequency of occurrence of heat stroke in the summer may be considered higher than the frequency of occurrence of irregular heart rhythm, so the priority order determining part 212d may determine the priority order so that the priority order of a model having an output parameter of the “probability of occurrence of heat stroke” becomes higher than the priority order of a model having an output parameter of the “probability of an irregular heart rhythm”. On the other hand, there is a high possibility of recovery from a heat stroke if resting, but irregular heart rhythm sometimes has a direct impact on health, so irregular heart rhythm may be considered to be more risky to human life than heat stroke. For this reason, the priority order determining part 212d may determine the priority order based on the relationship between the output parameter and human life so that the priority order of the model having an output parameter of the “probability of irregular heart rhythm” becomes higher than the priority order of the model having an output parameter of the “probability of heat stroke” being learned.

Further, the priority order determining part 212d may determine the priority order in accordance to the difficulty of prediction of the value of the output parameter of the model. For example, for a model having an output parameter of the “probability of irregular heart rhythm”, it is possible to prepare a learned model with a relatively high precision based on the bio information (electrocardiogram or number of heart beats) successively obtained from devices which persons inside the smart city 100 wear (wearable devices etc.) On the other hand, for a model having an output parameter of the “probability of heat stroke”, this is susceptible to the air temperature, humidity, and other weather conditions. It is necessary to perform learning adding the weather conditions to the bio information. Preparation of a high precision learned model is sometimes accompanied with greater difficulty than the model having an output parameter of the “probability of irregular heart rhythm”. For this reason, the difficulty of prediction of the “probability of heat stroke” can become higher than the difficulty of prediction of the “probability of irregular heart rhythm”. Further, regarding an irregular heart rhythm, it is possible to directly alert the user based on the results of measurement of the electrocardiogram and number of heart beats using a wearable device etc. Sometimes there is no need to use the results of learning. For this reason, the priority order determining part 212d may determine the priority order in accordance with the difficulty of prediction of the value of the output parameter of the model so that the priority order becomes higher the higher the degree of difficulty of prediction in the learning target. In this case, the priority order is determined so that the priority order of the model having an output parameter of the “probability of heat stroke” becomes higher than the priority order of the model having an output parameter of the “probability of irregular heart rhythm”.

In the above way, as factors determining the priority order of learning, the frequency of occurrence of events relating to the output parameter of the model, the relationship between the output parameter and human life, and the difficulty of prediction of the value of the output parameter may be mentioned. Therefore, in embodiments, the priority order determining part 212d determines the priority order based on the value obtained by multiplying at least two of the indicators (coefficients) expressing the frequency of occurrence of events relating to the output parameter of the model, the relationship between the output parameter and human life, and the difficulty of prediction of the value of the output parameter. Note that, tables expressing the frequency of occurrence of events relating to the output parameter of the model, the relationship between the output parameter and human life, and the difficulty of prediction of the value of the output parameter may be stored in advance in the storage device 220.

Further, the priority order determining part 212d may dynamically change the priority order in accordance with the dynamic change in the frequency of occurrence of events relating to the output parameter of the model. For example, if the “probability of heat stroke” is the output parameter of the model, the probability of heat stroke will change in accordance with the weather and the season. When the weather is rainy or cloudy or when the winter season, the frequency of occurrence of heat stroke becomes low. Therefore, when the winter season, there is relatively less need to make the priority order of learning of a model having an output parameter of the “probability of heat stroke” higher compared with learning of other models. On the other hand, the frequency of occurrence of colds or hypothermia becomes higher the more wintery the season and the lower the air temperature. Therefore, the priority order determining part 212d may change the priority order based on the change of frequency of occurrence of events relating to the output parameter of the model in accordance with the weather or season. Note that, tables expressing the change in the frequency of occurrence in accordance with the weather or season for each output parameter of the model may be stored in advance in the storage device 220. Due to the above, the model with the highest priority order at the time of the start of learning among the dynamically changing priority orders is learned with priority.

The priority order judging part 212e of the processor 212 judges the priority order of learning when several models are set to the standby state of learning and there is competition in learning of several models. Further, the priority order judging part 212e judges the priority orders of a model being learned and models in the learning standby state when there is already a model being learned and one or more models are set to the standby state of learning. The priority order judging part 212e judges the priority order of learning based on a predetermined priority order or a priority order determined by the priority order determining part 212d.

If the numbers of data sets required for learning have been prepared for several models, the learning part 212f of the processor 212 prepares the learned model by machine learning with priority the model with a higher priority order among the models for which the number of data sets required for learning have been prepared based on the priority order of learning among the models. In particular, the priority order of learning of a model having an output parameter of a parameter relating to human life is set higher than the priority order of learning of a model with an output parameter not related to human life, so the learning part 212f machine learns a model having an output parameter of a parameter relating to human life with priority over a model with an output parameter not related to human life.

Specifically, during the learning of a model, even if there are models for which the numbers of data sets required for learning have been prepared and which are standing by for learning, the learning part 212f does not learn the standing by models until the model being learned finishes being learned and learns the model with a higher priority order among the standing by models with priority when the model being learned finishes being learned.

Further, if the priority order of learning of a model for which the number of data sets required for learning have been newly prepared is higher than the priority order of learning of the model currently being learned, the learning part 212f suspends the learning of model currently being learned and learns with priority the model for which the number of data sets required for learning have been newly prepared.

The learning part 212f, in embodiments, machine learns with priority the single model with the highest priority order. On the other hand, if it is possible to machine learn two or more models in parallel in accordance with the processing ability of the processor 212 and processing load of learning, the learning part 212f may also machine learn two or more models with high priority orders in parallel.

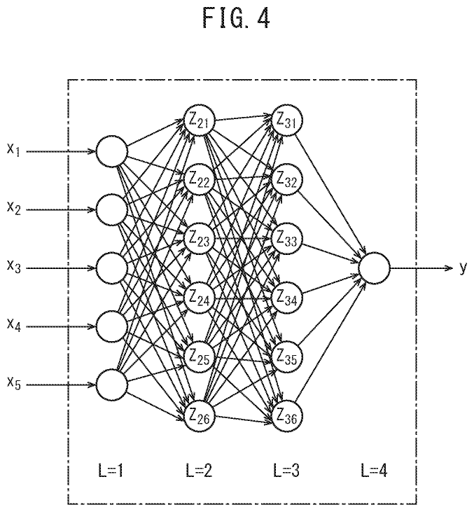

FIG. 4 is a schematic view showing one example of a neural network by which the learning part 212f performs learning based on learning use data sets and prepares a learned model. Note that, the neural network itself shown in FIG. 4 is already known, so it will be explained in brief. The circle marks in FIG. 4 represent artificial neurons. In a neural network, such artificial neurons are usually called “nodes” or “units” (here, called “nodes”). In FIG. 4, L=1 indicates the input layer, L=2 and L=3 indicate hidden layers, and L=4 indicates the output layer. As shown in FIG. 4, the input layer (L=1) is comprised of five nodes. The input values x₁, x₂, x₃, x₄, and x₅ are input to the nodes of the input layer (L=1). On the other hand, in FIG. 4, two layers of the hidden layer (L=2) and the hidden layer (L=3) having six nodes are schematically shown, but the number of the hidden layers may be one layer or any other number as well. Further, the numbers of nodes present at these hidden layers may be made any numbers. z₂₁, z₂₂, z₂₃, z₂₄, z₂₅, and z₂₆ show the output values from the nodes of the hidden layer (L=2), while z₃₁, z₃₂, z₃₃, z₃₄, z₃₅, and z₃₆ show the output values from the nodes of the hidden layer (L=3). Note that, there is a single node at the output layer (L=4) and the output value from the node of the output layer is shown by “y”.

At the nodes of the input layer (L=1), the input values x₁, x₂, x₃, x₄, and x₅ are output as they are. On the other hand, at the nodes of the hidden layer (L=2), the values of the output values x₁, x₂, x₃, x₄, and x₅ of the nodes of the input layer are input. At the nodes of the hidden layer (L=2), the respectively corresponding weights “w” and biases “b” are used to calculate the sum input value u₂ₖ=Σx·w+b(k=1˜6).

Next, this sum input value u₂ₖ is converted by an activation function “f” and output from the nodes shown by z₂ₖ of the hidden layer (L=2) as the output value z₂ₖ (=f(u₂ₖ)). On the other hand, at the nodes of the hidden layer (L=3), the output values z₂₁, z₂₂, z₂₃, z₂₄, z₂₅, and z₂₆ of the nodes of the hidden layer (L=2) are input. At the nodes of the hidden layer (L=3), the respectively corresponding weights “w” and biases “b” are used to calculate the sum input value u₃ₖ=Σz·w+b(k=1˜6). This sum input value u₃ₖ is similarly converted by an activation function and output from the nodes of the hidden layer (L=3) as the output z₃₁, z₃₂, z₃₃, z₃₄, z₃₅, and z₃₆. As the activation function, for example, a Sigmoid function σ(x)=1/(1+exp(−x)), a rectifier (ReLU)S(u)=max(0, u), etc. is used.

On the other hand, at the node of the output layer (L=4), the output values z₃₁, z₃₂, z₃₃, z₃₄, z₃₅, and z₃₆ of the nodes of the hidden layer (L=3) are input. At the node of the output layer, the respectively corresponding weights “w” and biases “b” are used to calculate the sum input value u₄ₖ=Σz·w+b or only the respectively corresponding weights “w” are used to calculate the sum input value u₄ₖ=Σz·w. In this example, at the node of the output layer, an identity function is used. From the node of the output layer, the sum input value u₄ₖ calculated at the node of the output layer is output as is as the output value “y”. Note that, there may also be two or more nodes of the output layer.

One data set which the learning use data set preparing part 212b prepares includes the input values x₁, x₂, x₃, x₄, and x₅ and the teacher data yₜ for the input values x₁, x₂, x₃, x₄, and x₅. The teacher data yₜ is found for a certain input value. If the output value from the output layer (L=4) for this input value is “y”, if using the square error as the error function, the square error E is found by E=(½)·(y−yₜ)².

The learning part 212f inputs the input values contained in the learning use data set into the neural network and calculates the square error E from the obtained output value “y” and the teacher data yₜ contained in the data set. Further, the learning part 212f minimizes the sum of the square error E obtained from a plurality of learning use data sets by, for example, error backpropagation, stochastic gradient descent, or other processing to calculate the weights “w” and biases “b” of the nodes to thereby prepare the learned model.

As explained above, the learning use data sets which the learning use data set preparing part 212b prepares differs depending on the model. As one example, in the case of a model having an output parameter of “the probability of a person inside the smart city 100 having a heat stroke”, the body temperatures and number of heart beats and other bio data of individual persons and the air temperature, humidity, amount of sunlight, and other data etc. are acquired as the input values x₁, x₂, x₃, x₄, and x₅, the probability of heat stroke is collected as the teacher data, and a single data set is formed. The probability of heat stroke (teacher data) is, for example, made “1” when an individual person would suffer from a heat stroke (would be transported by ambulance etc.), is made “0.5” when he or she would not be transported by ambulance, but has a body temperature higher than normal, and is made “0” in the case where he or she would not be transported by ambulance and there would be no abnormalities at all in the body temperatures. Further, the body temperature is made the input value x₁, the number of heart beats is made the input value x₂, the air temperature is made the input value x₃, the humidity is made the input value x₄, and the amount of sunlight is made the input value x₅. As the teacher data yₜ, the probability of heat stroke is input. If the learning part 212f learns several learning use data sets, a learned model receiving the body temperature, number of heart beats, and other bio data and the humidity, air temperature, amount of sunlight, and other data as input and outputting the probability of heat stroke is obtained.

Further, in the case of a model having of an output parameter of “an amount of electric power required for moving automated driving vehicles carrying visitors to the smart city 100”, the number of visitors to the smart city 100, the age of the visitors (average age), the number of persons heading to the visit spot A, the number of persons heading to the visit spot B, the weather, etc. are acquired as the input values x₁, x₂, x₃, x₄, and x₅, the amount of electric power consumed by the automated driving vehicles carrying the visitors is acquired as teacher data, and the result is made one data set. Note that, the age of the visitors is included in the input values because the higher the age, the fewer the people walking and the greater the number of people utilizing the automated driving vehicles. The age of the visitors becomes a factor changing the amount of electric power required for operating the automated driving vehicles. Further, the numbers of persons heading toward the visit spots A and B are included in the input values because the amount of electric power consumed by the automated driving vehicles differs depending on the destinations of the visits and the numbers of persons. The destinations of the visits and the numbers of persons become factors changing the amount of electric power required for operating the automated driving vehicles. Further, the weather is included in the input values because if the weather is rainy, the persons utilizing automated driving vehicles will increase, while if the weather is clear, the persons walking will increase and the persons utilizing automated driving vehicles will decrease, so the weather become a factor changing the amount of electric power required for operating the automated driving vehicles. In the case where a plurality of automated driving vehicles are operating, the amount of electric power consumed by the automated driving vehicles (teacher data) is made the total value of the amounts of electric power consumed by the individual automated driving vehicles. Further, the number of visitors to the smart city 100 is made the input value x₁, the age of the visitors is made the input value x₂, the number of persons heading to the visit spot A is made the input value x₃, the number of persons heading to the visit spot B is made the input value x₄, the weather is made the input value x₅, and the amount of electric power consumed by the automated driving vehicles carrying the visitors is input as the teacher data yₜ. If the learning part 212f learns the plurality of learning use data sets, a learned model is obtained having the number of visitors to the smart city 100, the age of the visitors (average age), the number of persons heading to the visit spot A, the number of persons heading the visit spot B, the weather, and other data as input and outputting the amount of electric power required for moving the automated driving vehicles carrying the visitors to the smart city 100.

If there is a model for which a reference number (second threshold value) of sets greater than the number required for learning (first threshold value) have been prepared, the learning part 212f, regardless of the priority order, may machine learn with priority the model for which the reference number of data sets have been prepared. Due to this, if performing learning based on only the priority order, there is a possibility of models with low priority orders no longer being learned, but models for which a second threshold value or more of learning use data sets are learned with priority over models with high priority orders, so learning of models with low priority orders no longer being learned can be avoided. Therefore, if the second threshold value or more of learning use data sets of a model not related to human life have been stored, the model not related to human life is learned with priority over a model related to human life. Note that, the second threshold value is a value determined for each model in the same way as the first threshold value.

Note that, when there is a model for which more than a reference number of data sets than the number required for learning have been prepared, instead of learning that model with priority, the learning part 212f may also learn with priority a model for which a predetermined time has elapsed after entering the learning standby state.

The storage processing part 212g of the processor 212 performs processing for storing a learned model prepared by the learning part 212f machine learning the learning use data sets at the storage device 220. The storage processing part 212g may also perform processing for updating, for any model, a learned model already stored in the storage device 220 by a learned model prepared by the learning part 212f machine learning the learning use data sets if the storage device 220 has already stored the learned model.

The learned model applying part 212h of the processor 212 inputs input values acquired from the various equipment 10 in the smart city 100 to any learned model and outputs the results of analysis of events relating to the learned model from the learned model.

The sending part 212i of the processor 212 sends the results of analysis which the learned model applying part 212h outputs from the learned model to the various equipment 10 in the smart city 100. Further, the sending part 212i sends a learned model prepared by the learning part 212f machine learning it by the learning use data sets to the various equipment 10 in the smart city 100 in accordance with requests from the various equipment 10.

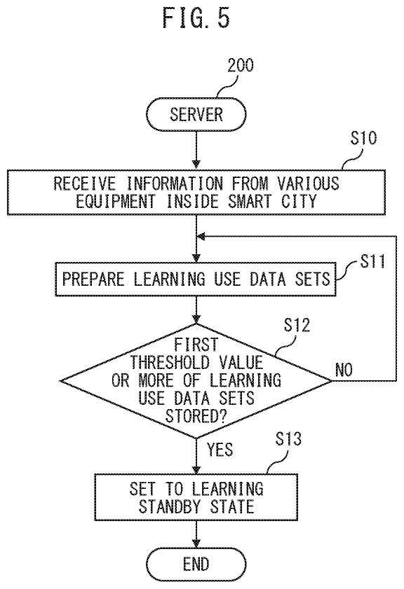

FIG. 5 is a flow chart showing processing which the processor 212 of the control device 210 of the server 200 performs. It is a flow chart showing the processing which the receiving part 212a, learning use data set preparing part 212b, and standby state setting part 212c of the processor 212 perform. The processing shown in FIG. 5 is performed by the processor 212 every predetermined control period. First, the receiving part 212a of the processor 212 receives information from the various equipment 10 in the smart city 100 through the communication network 300 (and the wireless base station 350) (step S10). Next, the learning use data set preparing part 212b of the processor 212 classifies and combines the various data included in the information which the receiving part 212a receives to therefore prepare learning use data sets for each model (step S11). The prepared learning use data sets are stored in the storage device 220 of the server 200.

Next, the standby state setting part 212c of the processor 212 judges if a first threshold value or more of the learning use data sets have been stored for any model (step S12). If a first threshold value or more of the learning use data sets have been stored, that model is set to the learning standby state (step S13). Note that, even after being set to the learning standby state, learning use data sets may continue being prepared and stored until the learning is started. On the other hand, if at step S12 a first threshold value or more of the learning use data sets have not been stored for any model, the routine returns to step S11 without that model being set to the learning standby state.

As explained above, according to the processing of FIG. 5, a model in which a first threshold value or more of learning use data sets is stored is set to the learning standby state.

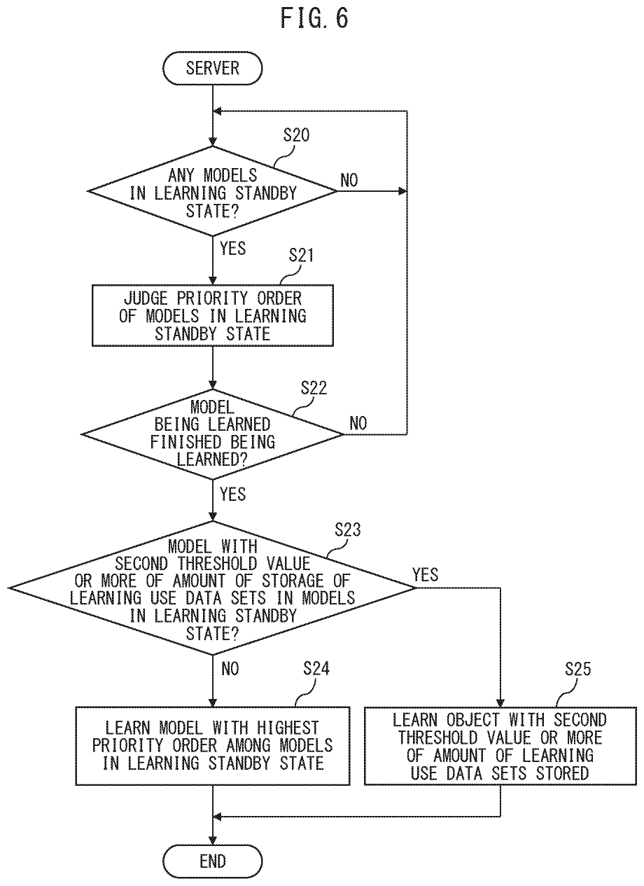

FIG. 6 is a flow chart showing processing which the processor 212 of the control device 210 of the server 200 performs. It is a flow chart of processing which the priority order judging part 212e and the learning part 212f of the processor 212 perform. The processing of FIG. 6 is performed by the processor 212 at each predetermined control period. First, it is judged if there is a model in the learning standby state (step S20). If there is a model in the learning standby state, the priority order judging part 212e judges the priority order of the model in the learning standby state (step S21). On the other hand, if at step S20 there is no model in the learning standby state, the routine stands by at step S20.

After step S21, it is judged if the model being learned is finished being learned (step S22). If the model being learned is finished being learned, it is judged if among the models in the learning standby state there is one with an amount of storage of learning use data sets of a second threshold value or more (step S23). On the other hand, if the model being learned has not finished being learned, the routine returns to step S20.

If at step S23 among the models in the learning standby state, there is none with the second threshold value or more of amount of storage of learning use data sets, the learning part 212f learns the model with the highest priority order among the models in the learning standby state (step S24).

On the other hand, if at step S23 among the models in the learning standby state, there is one with the second threshold value or more of amount of storage of learning use data sets, the learning part 212f learns the model with the second threshold value or more of amount of storage of learning use data sets (step S25). After steps S24 and S25, the processing ends.

Note that, if the processing ability of the processor 212 is not exceeded, at step S24, the learning part 212f may learn in parallel two or more models with high priority orders among the models in the learning standby state.

Further, if at step S23 there are a plurality of models with amounts of storage of learning use data sets of the second threshold value or more among the models in the learning standby state, at step S25, the learning part 212f machine learns with priority the one model with the highest priority order among the models with amounts of storage of learning use data sets of the second threshold value or more. In this case as well, if the processing ability of the processor 212 is not exceeded, at step S25, the learning part 212f may learn in parallel two or more models with high priority orders among the models with amounts of storage of learning use data sets of the second threshold value or more.

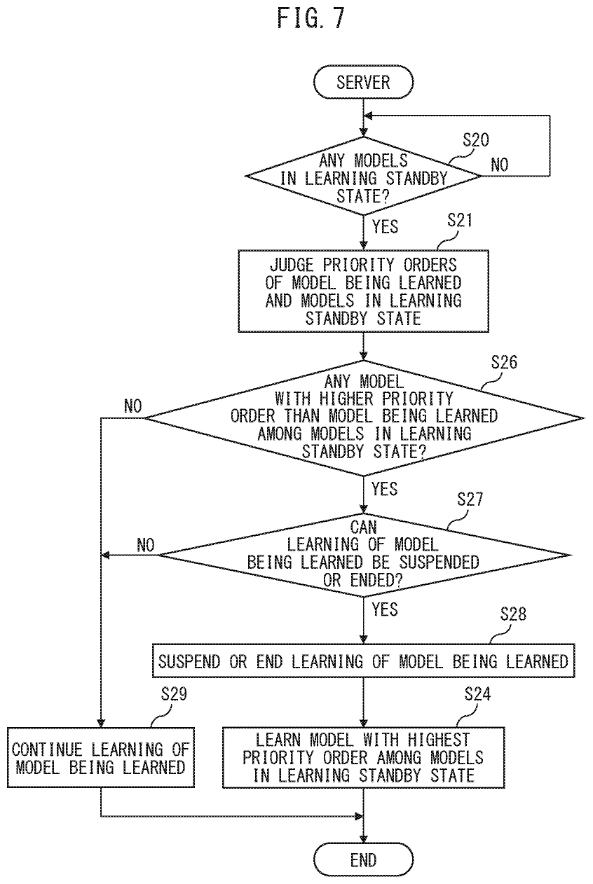

FIG. 7 is a flow chart showing the processing which the processor 212 of the control device 210 of the server 200 performs. It is a flow chart showing the processing for suspending learning in progress and learning a model in the learning standby state when there is already a model being learned in progress and the priority order of a model in the learning standby state is higher than the priority order of the model being learned. The processing of FIG. 7 is performed by the processor 212 at every predetermined control period. The flow chart of FIG. 7 mainly differs from the flow chart of FIG. 6 on the point that the processing of steps S26 to S29 is added and the processing of steps S22, S23, and S25 is not performed. Below, the explanation will be given centered about the points different from the processing of FIG. 6.

First, it is judged if there are models in the learning standby state (step S20). If there are models in the learning standby state, the priority order judging part 212e judges the priority orders of the model being learned and models in the learning standby state (step S21). On the other hand, if at step S20 there are no models in the learning standby state, the routine stands by at step S20.

After step S21, it is judged if among the models in the learning standby state, there is a model with a higher priority order than the model being learned (step S26). Further, if there is a model with a higher priority order than the model being learned among the models in the learning standby state, it is judged if the learning of the model being learned can be suspended or ended (step S27). If the learning of the model being learned can be suspended or ended, the learning part 212f suspends or ends the learning of the model being learned (step S28).

Note that, if, at step S27, an endpoint of the learning is in sight for the model being learned and the accuracy of the model can be secured, it is judged that the learning of the model being learned can be ended. Due to this, the model finished being learned can be utilized in a state where its accuracy can be secured.

After step S28, the learning part 212f learns the model with the highest priority order among the models in the learning standby state (step S24). Note that, if suspending the learning of the model being learned at step S28, the suspended learning is restarted after the learning of step S24 ends.

On the other hand, if at step S26 there is no model with a higher priority model than the model being learned among the models in the learning standby state or if at step S27 the learning of the model being learned cannot be suspended or ended, the learning part 212f continues the learning of the model being learned (step S29). After steps S24 and S29, the processing in the present control period is ended.

Note that, in the processing of FIG. 7 as well, the processing of steps S23 and S25 may be performed in the same way as FIG. 6.

Next, as a model relating to human life, an example of learning of the presence of any abnormality in behavior of the heart inside the smart city 100 and judging abnormality of behavior of the heart based on this will be explained. In this example, the communication interface 216 of the server 200 receives electrocardiogram information on which an electrocardiogram waveform expressing the behavior of the heart is expressed from wearable devices (electrocardio meters) which persons inside the smart city 100 wear through the communication network 300 and the wireless base station 350 and transfer it to the processor 212.

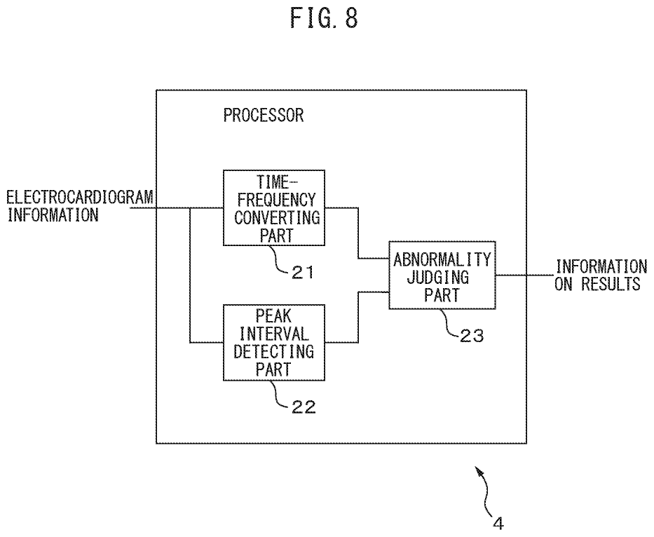

FIG. 8 is a functional block diagram showing the configuration of the learned model applying part 212h of the processor 212 of the control device 210 relating to the electrocardiogram information analysis processing. As shown in FIG. 8, the processor 212 has a time-frequency converting part 21, peak interval detecting part 22, and abnormality judging part 23.

The time-frequency converting part 21 divides an electrocardiogram waveform shown by electrocardiogram information into frame units having predetermined time lengths and performs time-frequency conversion on the electrocardiogram waveform for each frame to calculate the frequency spectrum of the electrocardiogram waveform. The time-frequency converting part 21 can use as the time-frequency conversion, for example, a Fast Fourier Transform (FFT). The time-frequency converting part 21 may perform the time-frequency conversion for each frame after multiplication by a window function such as a Hamming window or Hanning window. Alternatively, the time-frequency converting part 21 may use as the time-frequency conversion Discrete Cosign Conversion or Wavelet Conversion. The time length of the frame is, in embodiments, a length of for example several seconds to 10 odd seconds or so so that one frame contains several peaks of the predetermined types of electrocardiogram waveform (for example, R peaks).

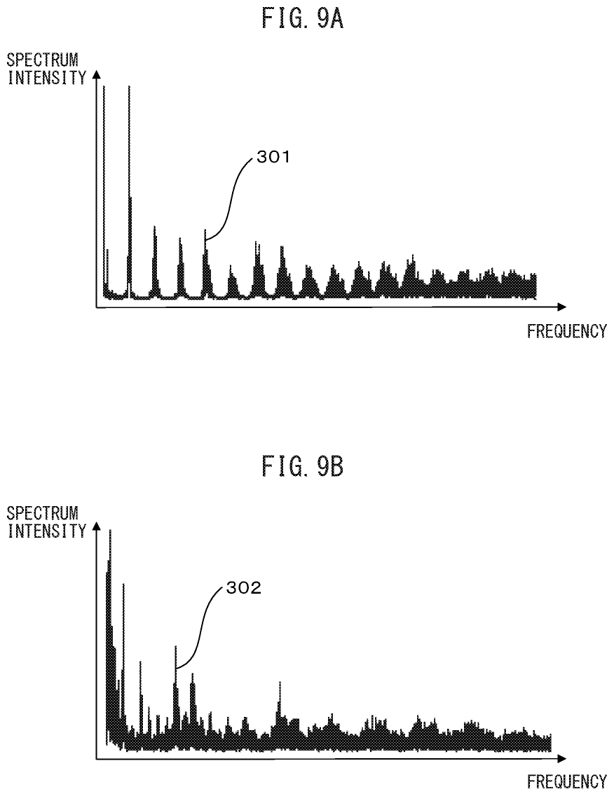

FIG. 9A and FIG. 9B are views showing examples of the frequency spectrums of electrocardiogram waveforms. In FIG. 9A and FIG. 9B, the abscissas show the frequency and the ordinates show the intensities of the spectrums. The waveform 301 shown in FIG. 9A shows the frequency spectrum for the electrocardiogram waveform in the case of no abnormality in behavior of the heart, while the waveform 302 shown in FIG. 9B shows the frequency spectrum for the electrocardiogram waveform in the case of abnormality in behavior of the heart such as atrial fibrillation.

As shown by the waveform 301 of FIG. 9A, if there is no abnormality in the behavior of the heart, in the frequency spectrum for the electrocardiogram waveform, clear peaks appear at every certain frequency interval. As opposed to this, as shown by the waveform 302 of FIG. 9B, if there is abnormality in the behavior of the heart, in the frequency spectrum for the electrocardiogram waveform, the frequency intervals at which the peaks appear become unclear. In this way, the frequency spectrum of an electrocardiogram waveform has waveform shapes differing according to any abnormalities in behavior of the heart, so becomes useful information for judging if there is any abnormality in the behavior of the heart.

The time-frequency converting part 21 outputs the frequency spectrum of the electrocardiogram waveform for each frame to the abnormality judging part 23.

The peak interval detecting part 22 detects at least two of the intervals between the same types of peaks and the intervals between different types of peaks of the electrocardiogram waveform shown in the electrocardiogram information.

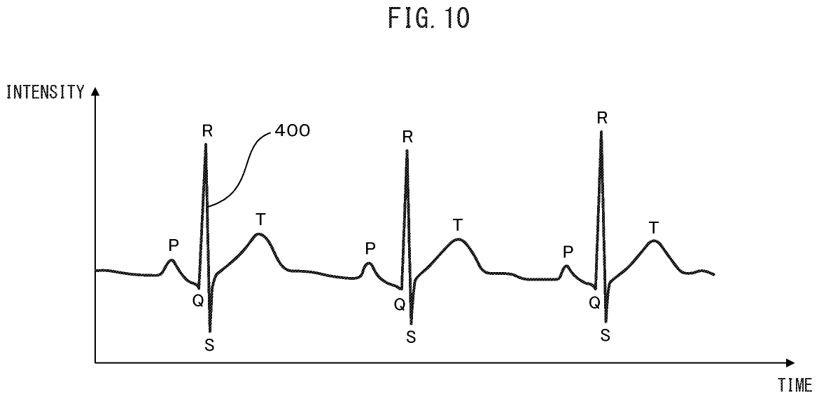

FIG. 10 is a view showing one example of an electrocardiogram waveform. In FIG. 10, the abscissa shows the time while the ordinate shows the intensity of the electrocardiogram signal. Further, the waveform 400 shows one example of an electrocardiogram waveform. In the electrocardiogram waveform 400, in general, for each beat of the heart, peaks called P, Q, R, S, T where the electrocardiogram signal becomes a maximal value or minimal value appear. The P peak is the peak appearing at the atrial excitation process. Further, the Q peak, R peak, and S peak respectively are peaks appearing in the ventricular excitation process. Further, the T peak is the peak appearing in the process of receding of the excitation of the ventricular muscle.

In the present embodiment, the peak interval detecting part 22 detects at least two, in some embodiments, three or more, of the intervals between two successive peaks of different types and two successive peaks of the same types among these peaks.

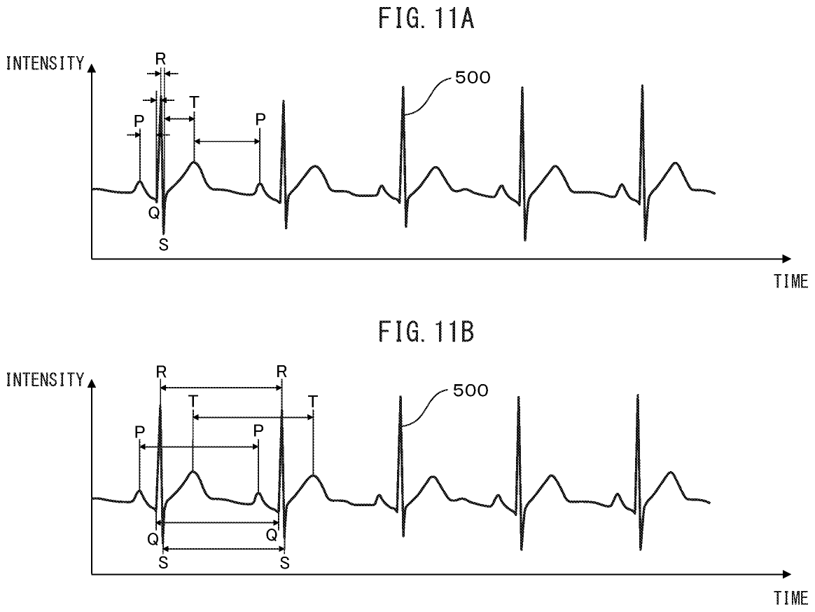

FIG. 11A and FIG. 11B are respectively views showing examples of intervals between two peaks which the peak interval detecting part 22 detects. In FIG. 11A and FIG. 11B, the abscissas show the time and ordinates show the intensities of the electrocardiogram signals. Further, the waveform 500 shows one example of an electrocardiogram waveform. As shown in FIG. 11A, for example, at least one of the P-Q interval between the P peak appearing in the waveform showing the same heart beat and the next appearing Q peak, the Q-R interval between the Q peak and the next appearing R peak, the R-S interval between the R peak and the next appearing S peak, the S-T interval between the S peak and the next appearing T peak, and the T-P peak between the T peak and the next appearing P peak of the next heart beat is detected by the peak interval detecting part 22. If only one among these peaks is detected, one or more of the intervals between the two successive peaks of the same type explained later are also detected. In embodiments, two or more or all of these intervals may be detected by the peak interval detecting part 22.

Further, as shown in FIG. 11B, for example, at least one among the interval between respective peaks of P, Q, R, S, and T appearing in the waveform expressing one heart beat and peaks of the same type appearing in the waveform showing the next heart beat, that is, the P-P interval, Q-Q interval, R-R interval, S-S interval, and T-T interval, may be detected by the peak interval detecting part 22. If only one of these peaks is detected, one or more of the intervals between two successive peaks of different types explained above are also detected. In embodiments, two or more or all of these intervals may also be detected by the peak interval detecting part 22.

The peak interval detecting part 22, in the same way as the time-frequency converting part 21, divides the electrocardiogram waveform appearing in the electrocardiogram information into frame units having predetermined time lengths. Further, the peak interval detecting part 22 investigates the changes along with time of the intensity of the electrocardiogram signal for each frame to detect the maximal values and minimal values of the electrocardiogram signal in an electrocardiogram waveform shown in the electrocardiogram information to thereby detect the respective types of peaks. For example, the peak interval detecting part 22 detects the maximal values or minimal values as peaks when the absolute value of the difference between the intensity of the electrocardiogram signal becoming the maximal value or minimal value and the intensity of the electrocardiogram signal around it becomes a predetermined threshold value or more. Alternatively, the peak interval detecting part 22 may detect the peaks by any of the various techniques for detecting the respective types of peaks from the electrocardiogram waveform. Further, the peak interval detecting part 22 may calculate the difference of timings of appearance of two peaks for detection of the peak intervals so as to detect the peak intervals.

At that time, the peak interval detecting part 22 may lighten the effect of noise superposed on the electrocardiogram waveform to more accurately detect the peaks by applying to the electrocardiogram waveform a bandpass filter decreasing the frequency components other than a predetermined frequency band. Further, the peak interval detecting part 22 may apply a bandpass filter to detect the peaks and peak intervals from the electrocardiogram waveform reduced in noise. Note that, the predetermined frequency band may, for example, be a band including frequency components corresponding to the peaks, for example, the 1 to 100 Hz band. In embodiments, the predetermined frequency band can be made the 2 to 40 Hz band. Further, if one frame contains a plurality of peak intervals of the same type, the peak interval detecting part 22 may make the average value of these peak intervals the peak interval again. For example, if one frame includes a plurality of R-R intervals, the peak interval detecting part 22 may make the average value of these plurality of R-R intervals the R-R interval in that frame.

The peak interval detecting part 22 outputs the two or more detected peak intervals to the abnormality judging part 23 for each frame.

The abnormality judging part 23 inputs the frequency spectrum of the electrocardiogram waveform and one or more peak intervals for each frame to the learned model learned in advance to judge the presence of any abnormality of the heart so as to judge if there is an abnormality in the behavior of the heart of a subject.

Note that, the abnormality judging part 23 may also input to the learned model the values of the individual frequencies included in a predetermined frequency band with a high relevance with the behavior of the heart in the frequency spectrum of the electrocardiogram waveform. Further, the abnormality judging part 23 may also input one or more peak intervals into the learned model from not the input layer, but any hidden layer.

Furthermore, the learned model may also output different values according to the type of abnormality detected. Such a learned model is learned in advance in accordance with a predetermined supervised learning technique such as error backpropagation using the teacher data such as explained above. Due to this, the abnormality judging part 23 can accurately judge if there is an abnormality in the behavior of the heart of a person inside the smart city 100.

Note that, the abnormality judging part 23 may also use as an identifier an identifier using a machine learning technique other than a neural network. For example, the abnormality judging part 23 may also use a support vector machine as the abnormality judging part 23.

The abnormality judging part 23 detects an abnormality in the behavior of the heart if the learned model outputs the result of judgment of there being an abnormality in the behavior of the heart for some sort of frames. On the other hand, if the learned model outputs a result of judgment of no abnormality in the behavior of the heart for any frame regarding the electrocardiogram information, the abnormality judging part 23 judges there is no abnormality in the behavior of the heart. Note that, the abnormality judging part 23 may also judge there is an abnormality in behavior of the heart only if the learned model outputs a result of judgment of there being an abnormality in the behavior of the heart in a predetermined number (for example, two or more) of frames in a most recent predetermined time period. Further, the abnormality judging part 23 outputs information showing the results of detection regarding the presence of any abnormality of the behavior of the heart through the communication interface 216 to wearable devices or other equipment inside the smart city 100. Note that, when the learned model outputs information showing the type of abnormality as well, the abnormality judging part 23 may include information showing the type of abnormality obtained from the learned model to information showing the above results of detection.

As explained above, according to the present embodiment, by the models to be learned being assigned priority orders, the learning is successively performed in accordance with the priority order, so it becomes possible to learn diverse and numerous models without exceeding the processing ability of the server 200.

1. An information processing device for machine learning a plurality of models with different output parameters, the information processing device comprising:
a processor configured to:
receive information from a plurality of equipment connected to be able to communicate,
prepare a learning use data set for each model by using information which said receiving part receives,
start learning of a model when the number of data sets required for learning have been prepared, and
machine learn with priority a model with a high priority order in models for which the number of data sets required for learning have been prepared based on the priority orders of learning among models if the number of data sets required for learning have been prepared for a plurality of models,
wherein the processor is configured to, during learning of models, even if there are models for which the number of data sets required for learning have been prepared and which are standing by for learning, not learn the standing by models until the model being learned finishes being learned and machine learn with priority a model with a high priority order among said standing by models if the model being learned finishes being learned.

2. An information processing device for machine learning a plurality of models with different output parameters, the information processing device comprising:
a processor configured to:
receive information from a plurality of equipment connected to be able to communicate,
prepare a learning use data set for each model by using information which said receiving part receives,
start learning of a model when the number of data sets required for learning have been prepared, and
machine learn with priority a model with a high priority order in models for which the number of data sets required for learning have been prepared based on the priority orders of learning among models if the number of data sets required for learning have been prepared for a plurality of models,
wherein the processor is configured to, if a priority order of learning of a model for which the number of data sets required for learning have newly been prepared is higher than a priority order of learning of the model currently being learned, suspend learning of the model currently being learned and learn by priority said model for which the number of data sets required for learning have newly been prepared.

3. An information processing device for machine learning a plurality of models with different output parameters, the information processing device comprising:
a processor configured to:
receive information from a plurality of equipment connected to be able to communicate,
prepare a learning use data set for each model by using information which said receiving part receives,
start learning of a model when the number of data sets required for learning have been prepared, and
machine learn with priority a model with a high priority order in models for which the number of data sets required for learning have been prepared based on the priority orders of learning among models if the number of data sets required for learning have been prepared for a plurality of models,
wherein the processor is configured to, if there is a model for which a reference number of data sets more than the number required for said learning have been prepared, machine learn by priority said model for which the reference number of data sets have been prepared regardless of said priority order.

4. The information processing device according to claim 1, wherein a priority order of learning of a model having an output parameter of a parameter relating to human life is set higher than a priority order of learning of a model with an output parameter not related to human life.

5. The information processing device according to claim 1, the processor is further configured to determine said priority order based on a frequency of occurrence of a predetermined event when said output parameter is a probability of occurrence of the event, a relevance between an output parameter and human life, or a difficulty of prediction of a value of the output parameter.
